(19) United States
(12) Patent Application Publication
(10) Pub. No.: US 2024/0393810 A1
(43) Pub. Date: Nov. 28, 2024

(54) ERROR MAP SURFACE REPRESENTATION FOR MULTI-VENDOR FLEET MANAGER OF AUTONOMOUS SYSTEM

(71) Applicant: Siemens Corporation, Washington, DC (US)

(72) Inventors: Jose Luis Susa Rincon, Pittsburg, CA (US); Ines Ugalde Diaz, Redwood City, CA (US); Michael Jaentsch, Menzingen (DE); Joachim Feld, Nürnberg (DE)

(73) Assignee: Siemens Corporation, Washington, DC (US)

(21) Appl. No.: 18/695,376

(22) PCT Filed: Oct. 11, 2022
(86) PCT No.: PCT/US2022/046257

§ 371 Date: Mar. 26, 2024

Related U.S. Application Data
(60) Provisional application No. 63/254,288, filed on Oct. 11, 2021.

(51) Int. Cl. G05D 1/86; G05D 1/246; G05D 1/692

(52) U.S. Cl. CPC G05D 1/86; G05D 1/2465; G05D 1/692

(57) ABSTRACT

Current approaches to controlling robots from multiple vendors typically requires multiple software systems that define vendor-exclusive fleet manager or dispatch systems. Autonomous devices (e.g., robots, drones, vehicles) can be controlled from multiple vendors that use multiple locally sourced map. For example, maps from individual robots can be translated to a base map that can be used to command and control hybrid fleets of robots.

### BACKGROUND

Autonomous operations, such as robotic operations or autonomous vehicle operations, in unknown or dynamic environments present various technical challenges. Autonomous operations in dynamic environments may be applied to mass customization (e.g., high-mix, low-volume manufacturing), on-demand flexible manufacturing processes in smart factories, warehouse automation in smart stores, automated deliveries from distribution centers in smart logistics, and the like. In some cases, robots, for instance mobile robots or automated guided vehicles (AGVs), originate from different vendors and operate at the same location, so as to define a multi-vendor hybrid group or fleet. It is recognized herein that commanding and controlling such hybrid fleets often lacks efficiencies and capabilities. For example, current approaches to controlling robots from multiple vendors typically requires multiple software systems that define vendor-exclusive fleet manager or dispatch systems, that rarely can communicate, or coordinate operations with each other.

### BRIEF SUMMARY

Embodiments of the invention address and overcome one or more of the described-herein shortcomings by providing methods, systems, and apparatuses that determine errors associated with navigation of an autonomous device. For example, mapping and localization can be performed for path planning and navigations tasks associated with commanding and controlling autonomous devices (e.g., robots, drones, vehicles). Such devices might inherently operate on different maps. For example, mobile robots from multiple vendors might operate on different maps. In an example, local coordinate systems and individual robot poses can be translated to a global map that can be used to determine optimal scheduling, planning, command, and control of hybrid fleets of robots.

In an example aspect, a global fleet manager module or central management system can determine a plurality of locations within a physical environment so as to define a known path that connects the plurality of locations. Each location can be represented by a plurality of global coordinates of a global reference frame. As an autonomous device (e.g., robot, vehicle, drone) moves along the known path within the physical environment, the central management system can receive a plurality of positions from the autonomous device. The plurality of positions can define respective local coordinates of a local reference frame corresponding to the autonomous device. In an example, the central management system transforms the local coordinates of the local reference frame to the global reference frame, so as to define respective transformed local coordinates. The system can compare the transformed local coordinates to the global coordinates so as to determine remnant error values associated with the respective transformed local coordinates. Based on the error values, the system can generate a 3D representation corresponding to the physical environment. The 3D representation can indicate an amount of error throughout the physical environment. Thus, the 3D representation can indicate how the autonomous device should move through the physical environment to compensate for the amount of error. In another example aspect, based on the 3D representations, the autonomous device can be controlled to move along the path.

In some cases, one of multiple autonomous devices from the same vendor generate the 3D error representations, such that the rest of the autonomous devices from the same vendor can use the 3D error representations to move along the path or reach any location within the environment. Thus, in various examples, 3D representations or error maps are generated for each vendor. Additionally, or alternatively, the system can determine new locations within the physical environment so as to define a new path that connects the plurality of new locations. Based on the 3D representations, the autonomous devices can estimate navigation trajectories to move along the new path.

### BRIEF DESCRIPTION OF THE SEVERAL VIEWS OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 is a block diagram of an example control system that includes an example global fleet management system or module, in accordance with an example embodiment.

FIG. 2 depicts example ideal locations that are connected to define a path for an autonomous device, in accordance with an example embodiment.

FIG. 3 depicts example positions reported by an autonomous device as it travels along a path that defines ideal locations, in accordance with an example embodiment.

FIG. 4 depicts example error values between an ideal point and sample point that is reported by an autonomous device, in accordance with an example embodiment.

FIG. 5 is an example 3D error representation that is generated by the global fleet management module based on the error values defined between discrete samples of locations of the path and the locations reported by the autonomous device, in accordance with an example embodiment.

FIG. 6 is a flow diagram that depicts operations that can be performed by the global fleet management module, in accordance with another example embodiment.

FIG. 7 illustrates a computing environment within which embodiments of the disclosure may be implemented.

FIG. 8 is an example 3D error representation that is generated from the 3D representation of FIG. 5 being fitted to a continuous polynomial, in accordance with an example embodiment.

FIG. 9 is an example 3D error representation that is generated by the global fleet management module by fitting the discrete 3D representation of FIG. 5 to a fitted discrete representation, in accordance with an example embodiment.

### DETAILED DESCRIPTION

As an initial matter, it is recognized herein that various technical challenges exist in integrating and controlling hybrid fleets of robots within a single system. Technical challenges can be due to, among other things, specific robot vendors implementing different sensing modalities, navigation, localization, and mapping software, and restricting proprietary services and functions. In some cases, for example, different map formats, coordinate systems, and non-linear map distortions cause technical problems in translating a pose or position of a given robot from one map to another map. Additionally, or alternatively, the maps might not be available to use, share, or combine by a third party mapping software. As used herein, unless otherwise specified, autonomous mobile robots (AMRs) or robots, autonomous devices or vehicles, automated guided vehicles (AGVs), drones, and the like can be used interchangeably herein, without limitation. Robots in an industrial setting are often described herein for purposes of examples, though it will be understood that embodiments described herein are not limited to robots in an industrial setting, and all alternative autonomous devices and settings are contemplated as being within the scope of this disclosure.

By way of background, typically each robot vendor deploys their own fleet manager or dispatch system to control their own robots. It is recognized herein that such independent fleet managers or dispatchers can create conflicts in systems that include robots from different vendors, and can inhibit the use of valuable data from a hybrid robot fleet. In some cases, robots can share their position to other robots in beacon messages. It is recognized herein, however, that estimating the positions on a global map from the beacon messages by means of simplified linear transformations might not be sufficiently precise, for example, due to map distortions, localization errors, or ambiguities in different maps or different robots. Furthermore, another current approach to integrating robots from multiple vendors involves generating a global map from other maps or pieces, which can be referred to as map merging. It is further recognized herein that this approach can require that maps are always accessible and that maps define the same type, either or both of which is often not the case as a practical matter. In addition, there is no consensus or defined standards to create, communicate, and use maps among different vendors, which creates a wide variety of formats and representations difficult to combine or use between vendors and their autonomous devices. Further still, in other approaches hybrid fleets rely on ident points that define points-of-interest (e.g., pickup locations, charging stations, etc.) that are taught or provided to each vendor's map so that the points can be referenced by an ID from a global feet manager. It is also recognized herein that such an approach can require large engineering efforts and can be limited in capabilities as the number of robot vendors and indent points increases.

As used herein, unless otherwise specified, a local map refers to a map that is learned by one or more robots that are often from a single robot manufacturer or vendor. A global map refers to a base map that is used in a global fleet manager or central management system to orchestrate a fleet of robots, which may include robots from multiple manufacturers or vendors.

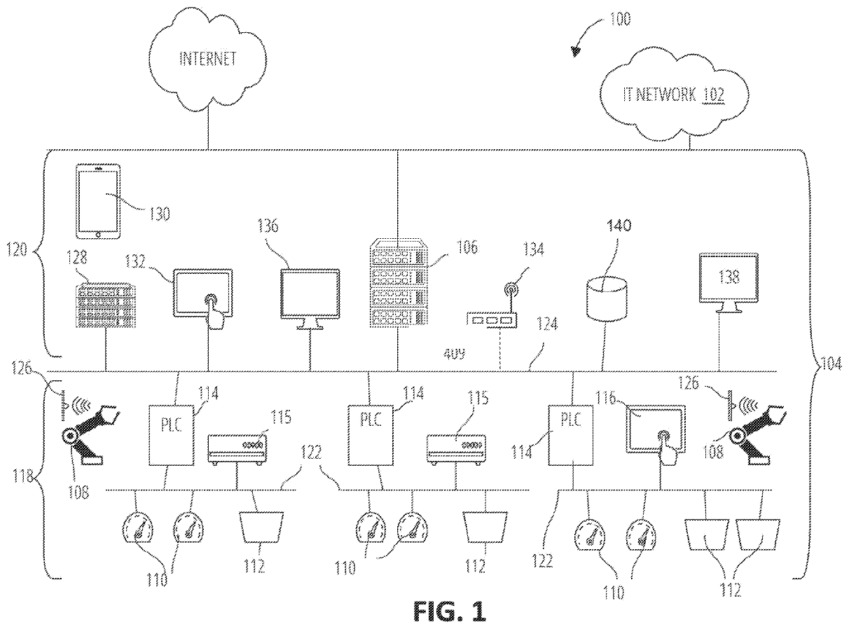

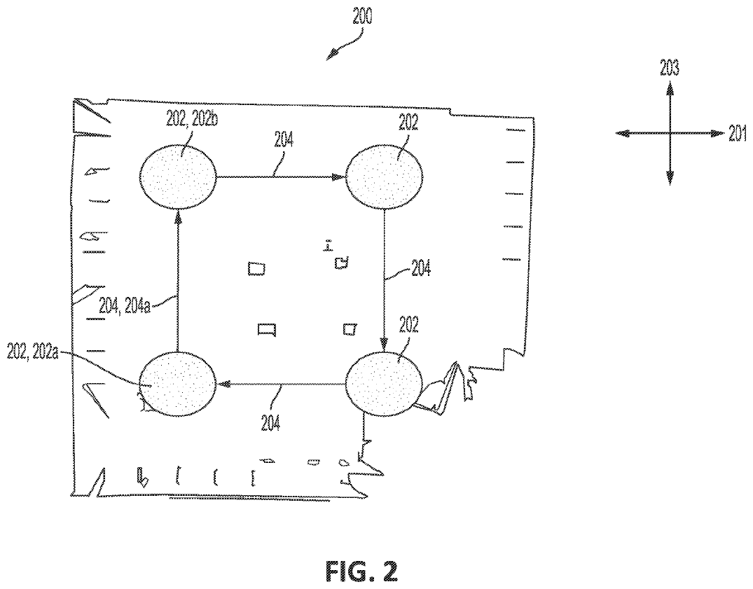

In accordance with various embodiments described herein, a hybrid fleet or central management system or module can translate map locations between a base or global map and individual maps of robot vendors, while taking into account various map distortions. Referring to FIG. 2, in some examples, a global fleet manager system or module or central management system (e.g., module 106 in FIG. 1) can define a base map, for instance a base map 200, representative of a physical environment. The base map 200 can define a plurality of locations or points, for instance locations or points 202 that represent physical locations in the physical environment represented by the base map 200. The base map 200 can further define edges or connections 204 between the points 202. Each point 202 can be represent by respective coordinates, for instance a first coordinate (e.g., x-coordinate) along a first or lateral direction 201, a second coordinate (e.g., y-coordinate) along a second or longitudinal direction 203 that is substantially perpendicular to the first direction 201, and a third coordinate (e.g., z-coordinate) along a third or transverse direction that is substantially perpendicular to both the first and second directions 201 and 203, respectively. Additionally, or alternatively, a point 202 can be represented by a fourth coordinate (e.g., theta) that represents a pose or orientation of a given robot at the corresponding point.

Referring to FIG. 2, the points 202 can be represented by x and y coordinates within a reference frame that can define a global reference frame. In various examples, the coordinates are bounded to an image that depicts the physical environment, such as an industrial floor plan or geographic area, for example. In an example, a robot is positioned or placed within the physical environment at one of the points 202, for instance a first point 202a, that is identified on the base map. The robot can be moved from the first point 202a to a second point 202b along a first connection 204a. As the robot moves within the physical environment, local poses of the robot can be captured and recorded. For example, the poses can be defined in a reference frame that is local to the robot, or local reference frame. By way of further example, the poses can define coordinates, for example (x, y, theta), which indicate the location of the robot as determined by the robot. The global fleet manager module can compare the reported poses or positions in the local reference frame to the points from the global reference frame (which can define ground-truth poses), so as to compute the parameters of a transformation, for instance a linear transformation, such as an affine or rigid body transformation, thereby defining a conversion between the local reference frame of the robot and the global reference frame. For example, the conversion or transformation can be defined according to equation (1):

$$\\ \begin{matrix}{T}_{tx , ty , θ ( x , y )} = [ \begin{matrix}cos θ & - sin θ & tx \\ sin θ & cos θ & ty \\ 0 & 0 & 1\end{matrix} ] [ \begin{matrix}x \\ y \\ 1\end{matrix} ] & ( 1 )\end{matrix}$$

With respect to equation (1), theta represents the rotation between the two different reference frames, and tx and ty represent the intercept or shift in X and Y axes respectively, between the two reference frames. In this particular example, there is no scale factor between the two different frames, but it is understood that a scale factor may also be incorporated in the equation to capture usage of different measurement units in the two reference frames, for example millimeters and meters conversions. Additionally, more dimensions (e.g., the Z axis, etc.) may be added to the affine transformation.

In an example aspect, a global fleet manager module or central management system can determine a plurality of locations within a physical environment so as to define a known path that connects the variety of locations. Each location can be represented by multiple global coordinates of a global reference frame. Each location can also be represented by multiple local coordinates of a local reference frame that is specific to a robot or type (e.g., vendor) of autonomous device. In an example, as autonomous devices (e.g., robot, vehicle, drone) moves along the known path within the physical environment, the central management system can receive a plurality of positions from the autonomous devices. The plurality of positions can define respective local coordinates of a local reference frame corresponding to the given autonomous device. Ian example, the central management system transforms the local coordinates of a location based on the local reference frame to the global reference frame, so as to define respective transformed local coordinates. In some cases, a linear transformation that considers scale, intercept, and rotation, is performed between the two coordinate frames. By way of example, transformations may be performed by employing Linear Regression, Local Search (hill climbing, etc.), or Non-Linear Regression on a set of known local and global poses. It is recognized herein, however, that in some cases, such linear transformations might not effectively capture the non-linearities inherent to the local maps (or local reference system coordinates), which can be generated by Simultaneous Localization and Mapping techniques (or similar) that operate on potentially noisy sensors and adversarial environment conditions. Thus, once the first linear transformation is obtained, the system can observe or compare the transformed local coordinates and the actual global coordinates so as to determine error values associated with the respective transformed local coordinates. Based on the error values, the system can generate multiple 3D representations. Example 3D representations include (xₘₐₚ, yₘₐₚ, xₑᵣᵣₒᵣ) and (xₘₐₚ, yₘₐₚ, yₑᵣᵣₒᵣ), wherein each 3D representation defines an error value for each axis (xₑᵣᵣₒᵣ, yₑᵣᵣₒᵣ) for any point on the map (xₘₐₚ, yₘₐₚ) of the physical environment. Thus, the 3D representations can indicate how the autonomous device should be controlled to move through the physical environment to compensate for the amount of measured error, for instance to compensate for the amount of error for each axis x and y. In another example aspect, based on the 3D representations, the autonomous device can be controlled to move along the path. It will be understood that the x and y coordinates and their corresponding errors are presented by way of example, and additional or alternative coordinates and errors can be observed and evaluated, and all such coordinates and errors are contemplated as being within the scope of this disclosure. For example, the system may also observe errors along other dimensions and obtain similar 3D error representations for them, for example, along the rotation dimension or the Z axis.

In some cases, one of multiple autonomous devices from the same vendor defines the 3D error representations, such that the rest of the autonomous devices from the same vendor can be controlled to move along the path or reach any location on the environment. Additionally, or alternatively, the system can determine new locations within the physical environment so as to define a new path that connects the plurality of new locations. Based on the 3D representations, the autonomous devices can estimate navigation trajectories to move along the new path.

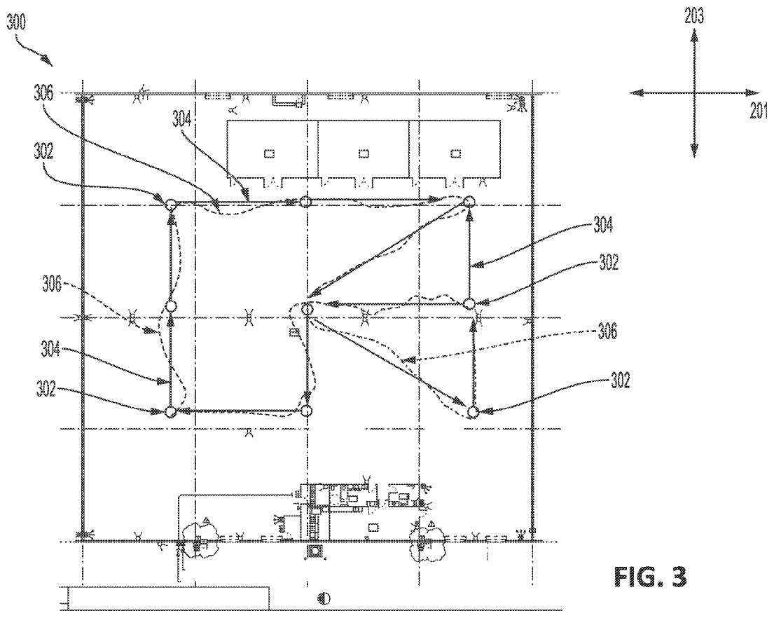

Referring also to FIG. 3, the global fleet manager module can define another example base map 300 that is representative of a physical environment, for instance a factory floor in which robots operate in an industrial setting. It will be understood that the factory floor is presented as an example of a physical environment, such that physical environments can define alternative maps (e.g., geographic areas of drones, roadways, warehouses, and the like), and all such alternatives are contemplated as being within the scope of this disclosure. The global fleet manager module can determine or obtain a plurality of points (checkpoints) or locations 302 within the physical environment (e.g., factory floor) so as to define a known path or trajectory 304 that connects the plurality of locations or checkpoints 302. Each location 302 and each point along the path 304 can be represented by global coordinates of a global reference frame, for instance the reference frame defined by the first and second directions 201 and 203, respectively. In some cases, the path 304 defines connections between locations 302 that define a 45 degree angle with respect to the axis of the global reference frame, for instance with respect to the first direction 201 and the second direction 203, so as to maximize the error samples that are captured. An autonomous device, for instance an industrial robot, can be moved in straight lines between the points or locations 302, so as move along the path 304. For example, the direction of the robot can be locked via a virtual joystick, a compass can be mounted on the robot, or the robot can be otherwise controlled so as to move along the path 304. As the robot moves along the path 304 within the physical environment, the system can receive a plurality of positions from the robot, so as to define reported positions 306 (or a reported trajectory 306). For example, the robot can send its positions 306 to the global fleet management module as it travels along the path 304. The plurality of reported positions 306 can define respective local coordinates of a local reference frame corresponding to the example.

With continuing reference to FIG. 3, the system can perform a linear transformation by employing a pair defined by a reported local pose (position) and a global pose (position) for a subset of the poses (positions). In some examples, the subset corresponds to the checkpoint poses. The linear transformation solution may be found via linear regression methods or the like, such as Least Squares method. Once the linear transformation is known, the reported local poses (positions) can be converted to global poses (positions), and can be represented by the trajectory 306 in FIG. 3. Thus, as illustrated, the result can depict evident divergences between the converted trajectory 306 and the actual straight driven trajectory 304. The system can then compare the poses or positions 306 reported by the robot to the corresponding coordinates along the path 304 in the base map 300, so as to determine an amount of error between the expected positions (from the path 304 in the global map) and the measured positions 306 (from the robot. The resulting error information for each coordinate, for instance the x-coordinate along the lateral direction 201 and the y-coordinate along the longitudinal direction 203, can be transformed into a 3D representation, for example (xₘₐₚ, yₘₐₚ, error value) for each coordinate (e.g., x and y), that illustrates the discrepancy between ideal poses or positions and measured poses or positions.

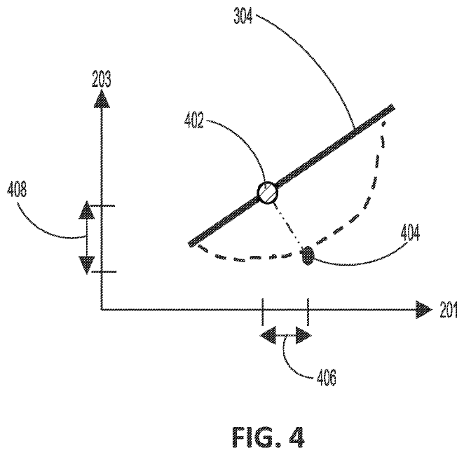

To further illustrate, referring to FIG. 4, an example ideal point 402 represents a point or location that is identified within the physical environment on a base or global map, for instance a location along the path 304 of the base map 300. An example sample point 404 represents a measured point or reported position converted to the global reference frame that is measured and reported by the robot as it travels along the path 304. The sample point 404 as compared to the ideal point 402 defines an error 406 along the lateral direction 201 that can be referred to as a first or lateral direction error 406 (or error in x-coordinate xₑᵣᵣₒᵣ). The sample point 404 as compared to the ideal point 402 defines an error 408 along the longitudinal direction y that can be referred to as a second or longitudinal direction error 408 (or error in y-coordinate yₑᵣᵣₒᵣ). The system can compute the error for each intermediate sample, in particular for the sample point 404, by computing the corresponding ideal point 402 in the perfectly straight actually driven trajectory 304 that results from the intersection between said trajectory 304 and the perpendicular line that passes through point 404. The error in the X axis xₑᵣᵣₒᵣ 406 and the error in Y axis yₑᵣᵣₒᵣ 408 are thus obtained as the difference between point 402 and point 406. It is understood that while this figure references only X and Y axis, the same methodology can be applied to a Z or other dimensions, and all such dimensions are contemplated as being within the scope of this disclosure

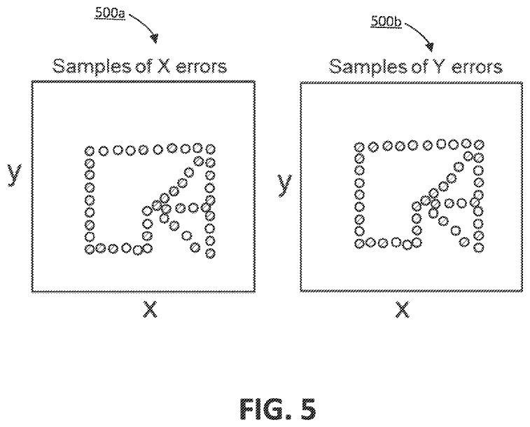

Referring generally to FIG. 5, based on the computed error values defined between the points along the ideal path, for instance the path 304, and corresponding reported positions, for instance the reported positions 306, the system can generate a 3D error representation, for instance a first dimension 3D representation 500a and a second dimension 3D representation 500b corresponding to the physical environment. The 3D representations can each define a set of error samples spread through the trajectory driven by the robots. Each dimension that was evaluated for non-linear errors can have its own 3D error representation. For example, the first dimension 3D representation 500a corresponds to the dimension along the first direction 201 or x-axis, (xₘₐₚ, yₘₐₚ, xₑᵣᵣₒᵣ) and the second dimension 3D representation 500b corresponds to the dimension along the second direction 203 or y-axis, (xₘₐₚ, yₘₐₚ, yₑᵣᵣₒᵣ). In some examples, the 3D error representations can be employed as-is, during the fleet operation, to map any local robot pose along the already visited trajectory into the global or base map, for example, so as to view the robot's current position in the global map. Similarly, any global pose along the already visited trajectory can be mapped to the local robot map, for example, so as to command the robot to move to said location. Additionally, or alternatively, the 3D error representation data can be used to approximate or predict the amount of error in non-visited areas.

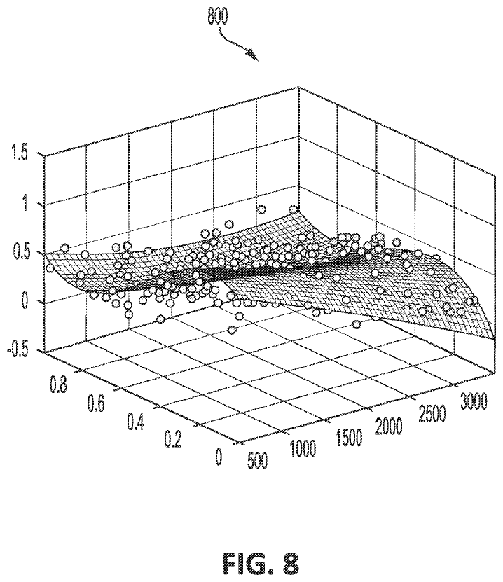

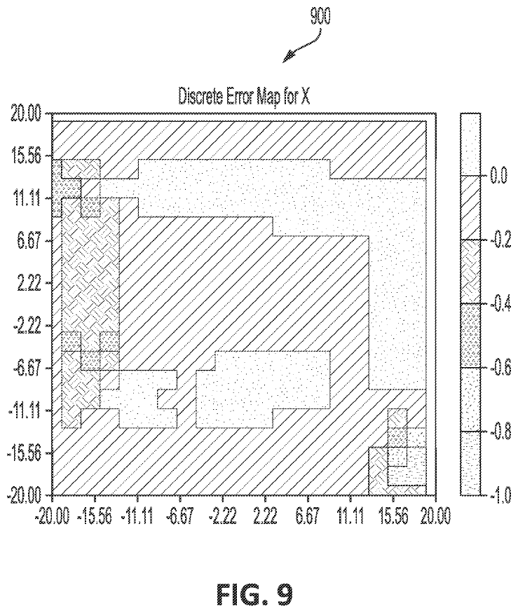

For example, referring to FIG. 8, an example continuous 3D error representation 800 depicts an example of how 3D error points can be fitted to a high-degree polynomial in 3D space. In such a representation, the error can be converted to a 3D function, thereby allowing any point, and not just points visited by the robot, to be sampled for errors. The fleet manager system can then query the error for novel positions, for either visualization or to command a robot. Referring also to FIG. 9, an example discrete 3D error representation 900 is shown. In the example discrete 3D error representation 900, the physical floor plane can be divided in a grid of user-defined resolution. All cells in the grid can be initialized with error value 0. The visited poses can be approximated to a cell in the grid, and the value of the cell can be that of the error value for the given visited pose. If multiple poses fit in the same cell, an average may be used to approximate the error value at the cell. The resulting grid can then apply a convolution operation with a smoothing kernel of user-defined size (e.g., Gaussian smoothing). The resulting grid can define a spread of the error along the nominal driven trajectory. Similar to the continuous approximation approach, the fleet manager system can query the error at any novel point, after approximating said point to a cell in the grid representation.

By way of example, if a given robot operates on an undistorted map and employs flawless sensors while driving the path, there will likely be virtually no errors on the coordinates such that the resulting error representation defines a two-dimensional plot over zero for each axis. Referring also again to FIG. 3, when the measured positions reported by the robot differ from the respective base that defines ideal locations, for instance due to map distortions or localization errors, the differences are reflected in the respective 3D representations.

In some cases, a given 3D representation can be updated when a robot moves, for example, when the actual driven trajectory is known and can be represented in the global map. For example, a robot can report its local poses as it drives the known trajectory, which are then converted to global poses using the linear transformation already known and stored in the system memory. Furthermore, novel points are then compared to the known trajectory in the base or ideal map, and new error samples can be obtained therein. The 3D error representations can be updated by aggregating the previous error samples with the novel error samples. In particular, for example, the third element (xₑᵣᵣₒᵣ or yₑᵣᵣₒᵣ) of the point represented in 3D on the map xₘₐₚ, yₘₐₚ can be updated. The error representation can then be remodeled using a continuous or discrete approach using the complete aggregated data (e.g., see FIGS. 8 and 9).

Thus, the 3D representations described herein can be used to calculate any position or location from a local vendor map to a base map employed in a multi-robot fleet manager, and visa-versa. In some cases, local-to-global transformations are needed to represent all relevant robots in the common base map, with the aim to visualize robots, plan or replan routes, and measure system throughput. This transformation can be obtained by applying the forward linear transformation (matrix multiplication). For example, given the local pose (X_1, Y_1) a corresponding global pose (X_g′, Y_g′) can be obtained. Then, the 3D error representation can be queried for the error at (X_g′, Y_g′) as (X_g_e′, Y_g_e′). The final global pose can be represented as (X_g′, Y_g′)+ (X_g_e′, Y_g_e′). Conversely, global-to-local transformations are can be required to transmit pose information to the individual vendor robots, with the aim to send motion commands, such as, for example, “move to charging station (point a) in (X_g_a, Y_g_a) coordinates” or “move to loading dock (point b) in (X_g_b, Y_g_b) coordinates”. In various examples, the process for obtaining the local representation of a global pose is the reverse of the local-to-global transformation. For example, the error can be applied to the global pose, then the inverse linear transformation can be applied to the error-adjusted pose, so as to result in the local pose. In the previous examples, the X and Y axis were considered, however, it is understood that the same methodology can be applied to further dimensions, such as the Z axis along the transverse direction. Thus, the 3D representation for a given physical environment can define a global error map to find points from/to the base or ideal map to/from the real environment for each robot from any vendor, with any mapping, localization, and navigation system.

Referring now to FIG. 1, an example industrial control system (ICS) 100 can include the global fleet manager system or module 106 described herein, though it will be understood that the global fleet manager system can be alternatively implemented. The example system 100 includes an office or corporate IT network 102 and an operational plant or production network 104 communicatively coupled to the IT network 102.

The production network 104 can include global fleet manager system 106 that can be connected to the IT network 102. The production network 104 can include various production machines configured to work together to perform one or more manufacturing operations. Example production machines of the production network 104 can include, without limitation, robots 108 and other field devices, such as sensors 110, actuators 112, or other machines, which can be controlled by a respective PLC 114. The PLC 114 can send instructions to respective field devices. In some cases, a given PLC 114 can be coupled to one or more human machine interfaces (HMIs) 116.

The ICS 100, in particular the production network 104, can define a fieldbus portion 118 and an Ethernet portion 120. For example, the fieldbus portion 118 can include the robots 108, PLC 114, sensors 110, actuators 112, and HMIs 116. The fieldbus portion 118 can define one or more production cells or control zones. The fieldbus portion 118 can further include a data extraction node 115 that can be configured to communicate with a given PLC 114 and sensors 110.

The PLC 114, data extraction node 115, sensors 110, actuators 112, and HMI 116 within a given production cell can communicate with each other via a respective field bus 122. Each control zone can be defined by a respective PLC 114, such that the PLC 114, and thus the corresponding control zone, can connect to the Ethernet portion 120 via an Ethernet connection 124. The robots 108 can be configured to communicate with other devices within the fieldbus portion 118 via a Wi-Fi connection 126. Similarly, the robots 108 can communicate with the Ethernet portion 120, in particular a Supervisory Control and Data Acquisition (SCADA) server 128, via the Wi-Fi connection 126. The Ethernet portion 120 of the production network 104 can include various computing devices communicatively coupled together via the Ethernet connection 124. Example computing devices in the Ethernet portion 120 include, without limitation, a mobile data collector 130, HMIs 132, the SCADA server 128, the abstraction engine 106, a wireless router 134, a manufacturing execution system (MES) 136, an engineering system(ES) 138, and a log server 140. The ES 138 can include one or more engineering workstations. In an example, the MES 136, HMIs 132, ES 138, and log server 140 are connected to the production network 104 directly. The wireless router 134 can also connect to the production network 104 directly. Thus, in some cases, mobile users, for instance the mobile data collector 130 and robots 108, can connect to the production network 104 via the wireless router 134. In some cases, by way of example, the ES 138 and the mobile data collector 130 define guest devices that are allowed to connect to the abstraction engine 106. The abstraction engine 106 can be configured to collect or obtain historical project information.

Example users of the ICS 100 include, for example and without limitation, operators of an industrial plant or engineers that can update the control logic of a plant. By way of an example, an operator can interact with the HMIs 132, which may be located in a control room of a given plant, so as to view or interact with the 3D representations generated by the global fleet manager module 106. Alternatively, or additionally, an operator can interact with HMIs of the ICS 100 that are located remotely from the production network 104 to view or interact with the 3D representations generated by the global fleet manager module 106. Similarly, for example, engineers can use the HMIs 116 that can be located in an engineering room of the ICS 100. Alternatively, or additionally, an engineer can interact with HMIs of the ICS 100 that are located remotely from the production network 104.

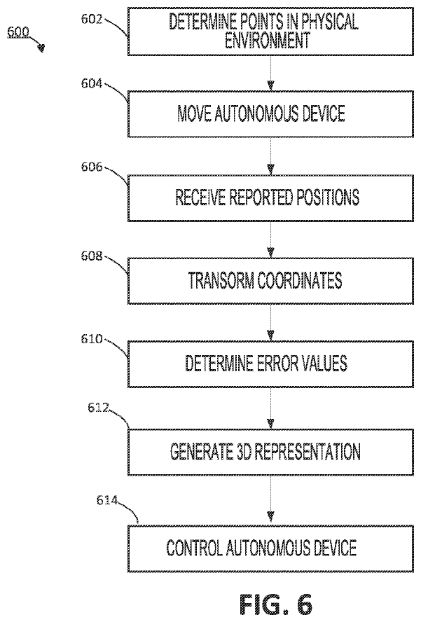

Referring now to FIG. 6, example operations 600 can be performed by the global fleet manager module 106. At 602, global fleet manager module 106 can determine or obtain a plurality of locations or points within a physical environment so as to define a path that connects the plurality of locations. Each location can be represented by a plurality of global coordinates of a global reference frame. At 604, an autonomous device can be moved along the path that defines the plurality of locations. As the autonomous device (e.g., robot, vehicle, drone) moves along the path within the physical environment, the system can receive a plurality of positions from the autonomous device, at 606. The plurality of positions can define respective local coordinates of a local reference frame corresponding to the autonomous device. In an example, at 608, the module 106 transforms the local coordinates of the local reference frame to the global reference frame, so as to define respective transformed local coordinates. At 610, the module 106 can compare the transformed local coordinates to the global coordinates so as to determine error values associated with the respective transformed local coordinates. Based on the error values, at 612, the system can generate a 3D error representation corresponding to the physical environment. The 3D representation can indicate how the autonomous device should be controlled to move through the physical environment based on the amount of error measured at 610. In another example aspect, based on the 3D error representation, the autonomous device can be controlled to move along the path.

In some cases, the autonomous device defines a first autonomous device from a first vendor. Furthermore, based on the based on the 3D representation, a second autonomous device second vendor that is different than the first vendor can be controlled to move along the path. Additionally, or alternatively, the system can determine new locations within the physical environment so as to define a new path that connects the plurality of new locations. Based on the 3D representation, the autonomous device can be controlled to move along the new path.

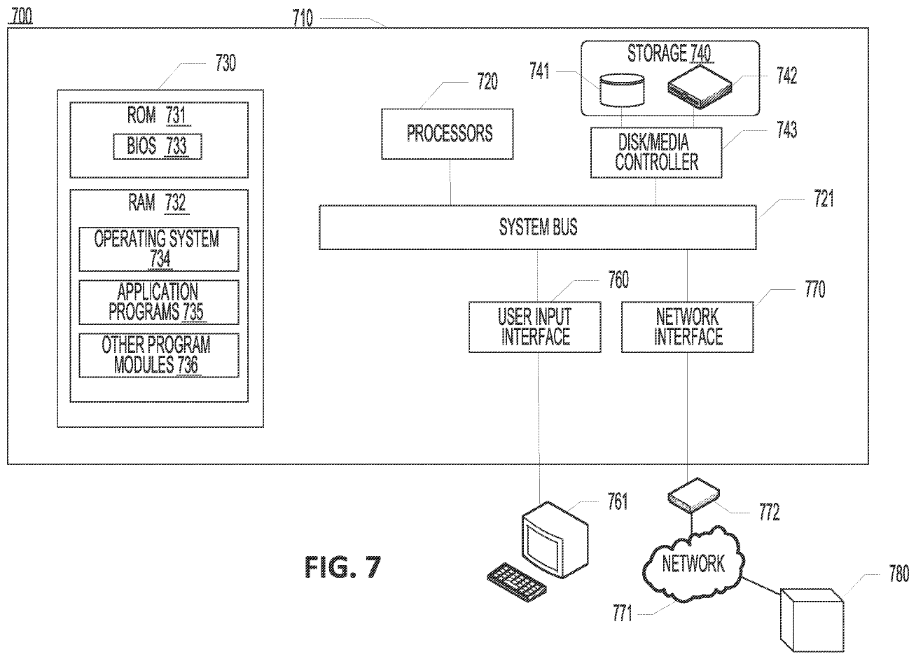

FIG. 7 illustrates an example of a computing environment within which embodiments of the present disclosure may be implemented. A computing environment 700 includes a computer system 710 that may include a communication mechanism such as a system bus 721 or other communication mechanism for communicating information within the computer system 710. The computer system 710 further includes one or more processors 720 coupled with the system bus 721 for processing the information. The global fleet manager module 106 may include, or be coupled to, the one or more processors 720.

The processors 720 may include one or more central processing units (CPUs), graphical processing units (GPUs), or any other processor known in the art. More generally, a processor as described herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general purpose computer. A processor may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 720 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor may be capable of supporting any of a variety of instruction sets. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

The system bus 721 may include at least one of a system bus, a memory bus, an address bus, or a message bus, and may permit exchange of information (e.g., data (including computer-executable code), signaling, etc.) between various components of the computer system 710. The system bus 721 may include, without limitation, a memory bus or a memory controller, a peripheral bus, an accelerated graphics port, and so forth. The system bus 721 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

Continuing with reference to FIG. 6, the computer system 710 may also include a system memory 730 coupled to the system bus 721 for storing information and instructions to be executed by processors 720. The system memory 730 may include computer readable storage media in the form of volatile and/or nonvolatile memory, such as read only memory (ROM) 731 and/or random access memory (RAM) 732. The RAM 732 may include other dynamic storage device(s) (e.g., dynamic RAM, static RAM, and synchronous DRAM). The ROM 731 may include other static storage device(s) (e.g., programmable ROM, erasable PROM, and electrically erasable PROM). In addition, the system memory 730 may be used for storing temporary variables or other intermediate information during the execution of instructions by the processors 720. A basic input/output system 733 (BIOS) containing the basic routines that help to transfer information between elements within computer system 710, such as during start-up, may be stored in the ROM 731. RAM 732 may contain data and/or program modules that are immediately accessible to and/or presently being operated on by the processors 720. System memory 730 may additionally include, for example, operating system 734, application programs 735, and other program modules 736. Application programs 735 may also include a user portal for development of the application program, allowing input parameters to be entered and modified as necessary.

The operating system 734 may be loaded into the memory 730 and may provide an interface between other application software executing on the computer system 710 and hardware resources of the computer system 710. More specifically, the operating system 734 may include a set of computer-executable instructions for managing hardware resources of the computer system 710 and for providing common services to other application programs (e.g., managing memory allocation among various application programs). In certain example embodiments, the operating system 734 may control execution of one or more of the program modules depicted as being stored in the data storage 740. The operating system 734 may include any operating system now known or which may be developed in the future including, but not limited to, any server operating system, any mainframe operating system, or any other proprietary or non-proprietary operating system.

The computer system 710 may also include a disk/media controller 743 coupled to the system bus 721 to control one or more storage devices for storing information and instructions, such as a magnetic hard disk 741 and/or a removable media drive 742 (e.g., floppy disk drive, compact disc drive, tape drive, flash drive, and/or solid state drive). Storage devices 740 may be added to the computer system 710 using an appropriate device interface (e.g., a small computer system interface (SCSI), integrated device electronics (IDE), Universal Serial Bus (USB), or FireWire). Storage devices 741, 742 may be external to the computer system 710.

The computer system 710 may also include a field device interface 765 coupled to the system bus 721 to control a field device 766, such as a device used in a production line. The computer system 710 may include a user input interface or GUI 761, which may comprise one or more input devices, such as a keyboard, touchscreen, tablet and/or a pointing device, for interacting with a computer user and providing information to the processors 720.

The computer system 710 may perform a portion or all of the processing steps of embodiments of the invention in response to the processors 720 executing one or more sequences of one or more instructions contained in a memory, such as the system memory 730. Such instructions may be read into the system memory 730 from another computer readable medium of storage 740, such as the magnetic hard disk 741 or the removable media drive 742. The magnetic hard disk 741 (or solid state drive) and/or removable media drive 742 may contain one or more data stores and data files used by embodiments of the present disclosure. The data store 740 may include, but are not limited to, databases (e.g., relational, object-oriented, etc.), file systems, flat files, distributed data stores in which data is stored on more than one node of a computer network, peer-to-peer network data stores, or the like. The data stores may store various types of data such as, for example, skill data, sensor data, or any other data generated in accordance with the embodiments of the disclosure. Data store contents and data files may be encrypted to improve security. The processors 720 may also be employed in a multi-processing arrangement to execute the one or more sequences of instructions contained in system memory 730. In alternative embodiments, hard-wired circuitry may be used in place of or in combination with software instructions. Thus, embodiments are not limited to any specific combination of hardware circuitry and software.

As stated above, the computer system 710 may include at least one computer readable medium or memory for holding instructions programmed according to embodiments of the invention and for containing data structures, tables, records, or other data described herein. The term “computer readable medium” as used herein refers to any medium that participates in providing instructions to the processors 720 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 741 or removable media drive 742. Non-limiting examples of volatile media include dynamic memory, such as system memory 730. Non-limiting examples of transmission media include coaxial cables, copper wire, and fiber optics, including the wires that make up the system bus 721. Transmission media may also take the form of acoustic or light waves, such as those generated during radio wave and infrared data communications.

Computer readable medium instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, may be implemented by computer readable medium instructions.

The computing environment 700 may further include the computer system 710 operating in a networked environment using logical connections to one or more remote computers, such as remote computing device 780. The network interface 770 may enable communication, for example, with other remote devices 780 or systems and/or the storage devices 741, 742 via the network 771. Remote computing device 780 may be a personal computer (laptop or desktop), a mobile device, a server, a router, a network PC, a peer device or other common network node, and typically includes many or all of the elements described above relative to computer system 710. When used in a networking environment, computer system 710 may include modem 772 for establishing communications over a network 771, such as the Internet. Modem 772 may be connected to system bus 721 via user network interface 770, or via another appropriate mechanism.

Network 771 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 710 and other computers (e.g., remote computing device 780). The network 771 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 771.

It should be appreciated that the program modules, applications, computer-executable instructions, code, or the like depicted in FIG. 6 as being stored in the system memory 730 are merely illustrative and not exhaustive and that processing described as being supported by any particular module may alternatively be distributed across multiple modules or performed by a different module. In addition, various program module(s), script(s), plug-in(s), Application Programming Interface(s) (API(s)), or any other suitable computer-executable code hosted locally on the computer system 710, the remote device 780, and/or hosted on other computing device(s) accessible via one or more of the network(s) 771, may be provided to support functionality provided by the program modules, applications, or computer-executable code depicted in FIG. 6 and/or additional or alternate functionality. Further, functionality may be modularized differently such that processing described as being supported collectively by the collection of program modules depicted in FIG. 6 may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in FIG. 6 may be implemented, at least partially, in hardware and/or firmware across any number of devices.

It should further be appreciated that the computer system 710 may include alternate and/or additional hardware, software, or firmware components beyond those described or depicted without departing from the scope of the disclosure. More particularly, it should be appreciated that software, firmware, or hardware components depicted as forming part of the computer system 710 are merely illustrative and that some components may not be present or additional components may be provided in various embodiments. While various illustrative program modules have been depicted and described as software modules stored in system memory 730, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted and described as sub-modules of another module, in certain embodiments, such modules may be provided as independent modules or as sub-modules of other modules.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure. In addition, it should be appreciated that any operation, element, component, data, or the like described herein as being based on another operation, element, component, data, or the like can be additionally based on one or more other operations, elements, components, data, or the like. Accordingly, the phrase “based on,” or variants thereof, should be interpreted as “based at least in part on.”

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for determining errors associated with navigation of an autonomous device, the method comprising:
determining a plurality of locations within a physical environment so as to define a known path that connects the plurality of locations, each location represented by global coordinates of a global reference frame;
as the autonomous device moves along the known path within the physical environment, receiving a plurality of positions from the autonomous device, the plurality of positions defining respective local coordinates of a local reference frame corresponding to the autonomous device;
transforming the local coordinates of the local reference frame to the global reference frame, so as to define respective transformed local coordinates;
comparing the transformed local coordinates to the global coordinates so as to determine remnant error values associated with the respective transformed local coordinates; and
based on the error values, generating a 3D representation corresponding to the physical environment, the 3D representation indicating an amount of error throughout the physical environment.

2. The method as recited in claim 1, the method further comprising:
performing linear transformations on local coordinates of the local reference frame, so as to define the respective transformed local coordinates.

3. The method as recited in claim 1, the method further comprising:
generating 3D representations for each respective coordinate of the local and global coordinates.

4. The method as recited in claim 1,
based on the 3D representations, controlling the autonomous device to move along the path.

5. The method as recited in claim 1, wherein the autonomous device defines a first autonomous device that operates on a first locally sourced map, the method further comprising:
based on the 3D representation, converting locally sourced poses of a second autonomous device that operates on a different map than the first locally sourced map of the first autonomous device.

6. The method as recited in claim 1, the method further comprising:
determining a plurality of new locations within the physical environment so as to define a new path that connects the plurality of new locations; and
based on the 3D representation, controlling the autonomous device to move along the new path.

7. The method as recited in claim 1, wherein the autonomous device defines a robot or vehicle, and the plurality of coordinates each define a first coordinate along a first direction, a second coordinate along a second direction that is substantially perpendicular to the first direction, and a third coordinate along a third direction that is substantially perpendicular to both the first and second directions.

8. The method as recited in claim 1, wherein the autonomous device defines a drone, and the plurality of coordinates each define a roll, pitch, and yaw.

9. A global fleet management system, the global fleet management system comprising:
a processor; and
a memory storing instructions that, when executed by the processor, cause the system to:
determine a plurality of locations within a physical environment so as to define a path that connects the plurality of locations, each location represented by global coordinates of a global reference frame;
as the autonomous device moves along the path within the physical environment, receive a plurality of positions from the autonomous device, the plurality of positions defining respective local coordinates of a local reference frame corresponding to the autonomous device;
transform the local coordinates of the local reference frame to the global reference frame, so as to define respective transformed local coordinates;
compare the transformed local coordinates to the global coordinates so as to determine error values associated with the respective transformed local coordinates; and
based on the error values, generate a 3D representation corresponding to the physical environment, based on the error values, the 3D representation indicating an amount of error throughout the physical environment.

10. The system as recited in claim 9, the memory further storing instructions that, when executed by the processor, further cause the system to:
perform linear transformations on local coordinates of the local reference frame, so as to define the respective transformed local coordinates.

11. The system as recited in claim 9, the memory further storing instructions that, when executed by the processor, further cause the system to:
generate 3D representations for each respective coordinate of the local and global coordinates.

12. The system as recited in claim 9, the memory further storing instructions that, when executed by the processor, further cause the system to:
based on the 3D representation, control the autonomous device to move along a desired path.

13. The system as recited in claim 9, wherein the autonomous device defines a first autonomous device that operates on a first locally sourced map, and the memory further stores instructions that, when executed by the processor, further cause the system to:
based on the 3D representation, convert locally sourced poses of a second autonomous device that operates on a different map than the first locally sourced map of the first autonomous device.

14. The system as recited in claim 9, the memory further storing instructions that, when executed by the processor, further cause the system to:
determine a plurality of new locations within the physical environment so as to define a new path that connects the plurality of new locations; and
based on the 3D representation, control the autonomous device to move along the new path.

15. The system as recited in claim 9, wherein the autonomous device defines a vehicle or robot, and the plurality of coordinates each define a first coordinate along a first direction, a second coordinate along a second direction that is substantially perpendicular to the first direction, and a third coordinate along a third direction that is substantially perpendicular to both the first and second directions.
